(19) United States
(12) Patent Application Publication
(10) Pub. No.: US 2013/0143598 A1
(43) Pub. Date: Jun. 6, 2013

(54) UMTS PROXIMITY DETECTION WITH UPLINK AND DOWNLINK SIGNALS

(71) Applicants: Navin Srinivasan, Fairfax, VA (US); Ariful Hannan, Sterling, VA (US); Tariqul Islam, Germantown, VA (US)

(72) Inventors: Navin Srinivasan, Fairfax, VA (US); Ariful Hannan, Sterling, VA (US); Tariqul Islam, Germantown, VA (US)

(73) Assignee: Andrew, LLC, Hickory, NC (US)

(21) Appl. No.: 13/309,975

(22) Filed: Dec. 2, 2011

(51) Int. Cl. H04W 24/00

(52) U.S. Cl. 455/456.2

(57) ABSTRACT

A method and system for determining the location of a mobile device in a communications network or the proximity of the device to a node in the network. A location request may be received for a mobile device served by a base station in the network. A set of nodes associated with the serving base station may then be tasked and downlink data collected at a first node, the downlink data from a downlink signal received from the serving base station. Downlink frame timing may then be determined as a function of the collected downlink data and uplink data collected at a second node as a function of the determined downlink frame timing. A geographic location for the device or proximity thereof to a node may be determined as a function of the collected uplink data.

### BACKGROUND

The structure and operation of wireless communication systems are generally known. Examples of such wireless communication systems include cellular systems and wireless local area networks, among others. In a cellular system, a regulatory body typically licenses a frequency spectrum for a corresponding geographic area (service area) that is used by a licensed system operator to provide wireless service within the service area. A plurality of base stations may be distributed across the service area. Each base station services wireless communications within a respective cell. Each cell may be further subdivided into a plurality of sectors.

Location based services for mobile stations are expected to play an important role in future applications of wireless systems. A wide variety of technologies for locating mobile stations have been developed. Many of these have been targeted towards the Federal Communication Commission's (“FCC”) requirement to determine the location of emergency 9-1-1 callers with a high degree of accuracy. The Wireless Communications and Public Safety Act (“the 911 Act”) was enacted to improve public safety by encouraging and facilitating the prompt deployment of a nationwide, seamless communications structure for emergency services. The 911 Act directs the FCC to make “911” the universal emergency number for all telephone services. Emergency (911) calls from landlines provide the emergency dispatchers with the telephone number and the address of the caller thereby assisting emergency personnel in locating the emergency. As mobile stations became more widely used, an increasing number of emergency (911) calls are being made from mobile stations without a fixed address. Emergency call centers have recognized that relying upon the caller to describe their location caused a delay in service. Many mobile emergency (911) callers were unable to accurately describe their location, resulting in a further delay and, often times, a tragic outcome.

In 1996, the FCC issued a report and order requiring all wireless carriers and mobile phone manufacturers to provide the capability for automatically identifying to emergency dispatchers the location from which a wireless call was made. Implementation was divided into two phases. Phase I required wireless service providers and mobile phone manufacturers to report the telephone number of the mobile phone making the call as well as the base station controlling the mobile station which provided a general area from which the call was made. This information can be obtained from the network elements. Phase II of the FCC's Enhanced 911 (“E-911”) mandate stated that by Oct. 1, 2002, wireless service providers must be able to pinpoint, by latitude and longitude, the location of a subscriber who calls emergency (911) from a mobile station. Wireless service providers were given the option of providing a network-based solution or a handset based solution. Wireless service providers who select a network-based solution are required to locate a mobile phone within 1000 meters 67% of the time.

Typical mobile station location technologies may be classified into external methods or network based methods. One example of an external method is the Global Positioning System (“GPS”). Network based methods may be further categorized depending on whether it is the network or the mobile station that performs necessary signal measurements. These signal measurements may involve the reception time of signals communicated between a base station (“BS”) and a mobile station (“MS”), the angle of arriving signals or round trip delay measurements of signals communicated between a serving BS and an MS, or combinations thereof.

For example, most location methods require specific hardware in the MS and/or in the network. Traditional networks include Mobile Station Controllers (“MSC”), Base Station Controllers (“BSC”) and Base Transceiver Station (“BTS”) systems that jointly operate to communicate with mobile stations over a wireless communication link. Examples of common networks include GSM networks, North American Time Division Multiple Access (“TDMA”) networks and Code Division Multiple Access (“CDMA”) networks. Extensive infrastructures (e.g., ANSI-41 or MAP-based networks) exist in the cellular wireless networks for tracking mobility, distributing subscriber profiles, and authenticating physical devices. In wireless mobile networks providing a facility to determine a mobile station's geographic position, a network component commonly referred to as a Mobile Location Center (“MLC”) performs the location calculation. Furthermore, in some networks, Location Measurement Units (“LMU”) may be generally required for some methods to obtain knowledge about the relative time differences for sending signals to different mobile stations.

To establish a wireless communication link in traditional wireless networks, an MSC communicates with a BSC to prompt the BTS (collectively, “BS”) to generate paging signals to a specified MS within a defined service area typically known as a cell or sector. The MS, upon receiving the page request, responds to indicate that it is present and available to accept an incoming call. Thereafter, the BS, upon receiving a page response from the MS, communicates with the MSC to advise it of the same. The call is then routed through the BS to the MS as the call setup is completed and the communication link is created.

One well-known method for locating a MS is triangulation. Signal power level or signal timing measurements between the MS and three or more base stations are used to triangulate. The signal power level or signal timing measurements are used to estimate the distance between each base station and the MS. The distances are plotted to determine a point of intersection. The point of intersection is the approximate transmitter location. For calculations using only signal power measurements, this method works only when the signal strength is relatively strong and not greatly affected by radio frequency (RF) fading, such as multipath interference common in urban environments. RF fading occurs when radiated signals encounter various obstacles that reflect and diffract the signal causing the received signal power level at the base station and mobile terminal to vary up to 30 dB. The requirement for a minimum of three base stations and the effect of RF fading limits the usefulness of triangulation.

Location techniques relying on measurements of timing differences, such as time difference of arrival (“TDOA”) or enhanced observed time difference (“E-OTD”), require signal timing measurements between the MS and three or more separate base stations. If the network's base stations are not time synchronized then extra equipment is required at each base station to measure the timing difference between base stations in the network. If the standard wireless network is not capable of collecting signal timing measurements between three or more base stations and the mobile terminal, modification of the standard base station and optionally the handset are required. The modification of base stations and optionally handsets implies significant additional cost to wireless network operators.

The development of the Global Positioning System (“GPS”) by the U.S. Department of Defense (“DoD”) provides a means to fix a position using a system of orbiting satellites with orbital planes that guarantee that at least four satellites are visible at all times. This system provides location accuracy to within one meter for military systems possessing a Selective Availability (“SA”) algorithm to filter out the intentional noise added to the signal. GPS systems without SA are limited to an accuracy of approximately 100 meters. Widespread use of the GPS and the decision to discontinue the LORAN-C navigation system convinced the DoD to drop SA thereby allowing commercial GPS receivers to dramatically increase accuracy. The FCC recognized that GPS receivers could be incorporated into mobile phones when it made minor adjustments to the Phase II schedule. Using GPS to report location, however, requires the mobile user to upgrade existing hardware or to purchase new hardware.

There is a need in the art for a method and apparatus to calculate a mobile station's location that avoids the limitations of the prior art such as the requirement for three or more separate base stations and one that does not require a mobile station or network hardware change to satisfy Phase I requirements while limiting the impact to the users and to the network operators. It is thus of interest to investigate what may be done with a minimum of network impact and expense.

Accordingly, there is a need for a method and system for determining the location of a device. The method may include receiving a location request for a mobile device served by a base station and tasking a set of nodes associated with the serving base station. Downlink (“DL”) data may be collected at a first node, the DL data from a DL signal received from the serving base station and DL frame timing determined as a function of the collected DL data. Uplink (“UL”) data may be collected at a second node as a function of the determined DL frame timing, and a location for the device determined as a function of the collected UL data.

A further embodiment of the present subject matter provides a method for determining the location of a mobile device served by a base station in a communications network. The method may include the steps of receiving a location request for the mobile device and collecting DL data from the serving base station. The method may further include determining a search window for UL data as a function of the collected DL data, collecting UL data at a network node as a function of the search window, and determining a location for the mobile device as a function of the collected UL data.

An additional embodiment of the present subject matter provides a method for determining the proximity of a mobile device to a node in a communications network. The method may include receiving a location request for a mobile device and tasking a set of nodes associated with a cell serving the mobile device associated with the location request. DL channel information may be obtained and DL frame timing determined as a function of the obtained DL channel information. UL channel information may be obtained as a function of the determined DL frame timing, and the proximity of the mobile device to the node determined as a function of the obtained UL channel information.

These embodiments and many other objects and advantages thereof will be readily apparent to one skilled in the art to which the invention pertains from a perusal of the claims, the appended drawings, and the following detailed description of the embodiments.

### BRIEF DESCRIPTION OF THE DRAWINGS

FIG. 1 is an illustration of a wireless communications network according to an embodiment of the present subject matter.

FIG. 2 is a diagram of a basic architecture for one embodiment of the present subject matter.

FIG. 3 is an illustration of the structure of a synchronization channel radio frame according to an embodiment of the present subject matter.

FIG. 4 is an illustration of the timing relationships between downlink physical channels according to an embodiment of the present subject matter.

FIG. 5 is an illustration of the timing relationships at a mobile device.

FIG. 6 is a block diagram of one embodiment of the present subject matter.

FIG. 7 is an illustration of Uplink DPCH timing at a PDU.

FIG. 8 is an illustration of a signal correlation scheme according to one embodiment of the present subject matter.

FIG. 9 is an algorithm according to one embodiment of the present subject matter.

FIG. 10 is an algorithm according to another embodiment of the present subject matter.

FIG. 11 is an algorithm according to a further embodiment of the present subject matter.

### DETAILED DESCRIPTION

With reference to the figures where like elements have been given like numerical designations to facilitate an understanding of the present subject matter, the various embodiments of a system and method for Universal Mobile Telecommunications System (“UMTS”) proximity detection with uplink (“UL”) and downlink (“DL”) signals are described herein.

The following description of the present subject matter is provided as an enabling teaching of the present subject matter and its best, currently-known embodiment. Those skilled in the art will recognize that many changes can be made to the embodiments described herein while still obtaining the beneficial results of the present subject matter. It will also be apparent that some of the desired benefits of the present subject matter can be obtained by selecting some of the features of the present subject matter without utilizing other features. Accordingly, those who work in the art will recognize that many modifications and adaptations of the present subject matter are possible and may even be desirable in certain circumstances and are part of the present subject matter. Thus, the following description is provided as illustrative of the principles of the present subject matter and not in limitation thereof. While the following exemplary discussion of embodiments of the present subject matter may be directed towards or references specific telecommunications systems, it is to be understood that the discussion is not intended to limit the scope of the present subject matter in any way and that the principles presented are equally applicable to other communications networks, systems and associated protocols.

Those skilled in the art will appreciate that many modifications to the exemplary embodiments described herein are possible without departing from the spirit and scope of the present subject matter. Thus, the description is not intended and should not be construed to be limited to the examples given but should be granted the full breadth of protection afforded by the appended claims and equivalents thereto. In addition, it is possible to use some of the features of the present subject matter without the corresponding use of the other features. Accordingly, the foregoing description of exemplary or illustrative embodiments is provided for the purpose of illustrating the principles of the present subject matter and not in limitation thereof and may include modification thereto and permutations thereof. The terms “device,” “handset,” and “station” are utilized interchangeably through the present disclosure and such use is not intended to limit the scope of the claims appended herewith. It should also be noted that the terms “node(s)” and “site(s)” and “station(s)” are also utilized interchangeably through the present disclosure and such use is not intended to limit the scope of the claims appended herewith.

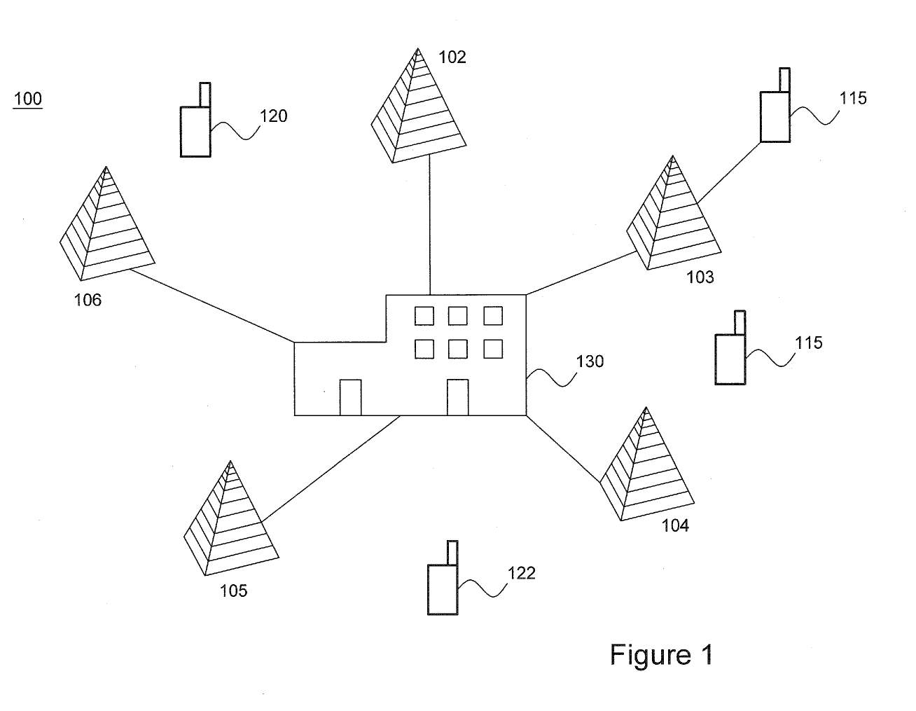

FIG. 1 is an illustration of a wireless communications network according to an embodiment of the present subject matter. With reference to FIG. 1, a wireless communications network 100 or system is shown. The network may be a UMTS network, a Global System for Mobile Communication (“GSM”) network, a Time Division Multiple Access (“TDMA”) network, Code Division Multiple Access (“CDMA”) network, a UMTS network, a Worldwide Interoperability for Microwave Access (“WiMax”) network, a WiFi network, networks utilizing Evolution-Data Optimized (“EDVO”), CDMA2000 network, 1 times Radio Transmission Technology (“1×RTT”) standards or another equivalent network.

Location measurement units (“LMU”) 115 may be dispersed throughout the system or subsystem reception area. These LMUs 115 may be integrated with a base station 102-106 or may be independent of a base station 102-106. The wireless network 100 serves mobile stations or devices 120, 122 within reception range of at least one of the base stations 102-106. Mobile stations 120, 122 may include cellular telephones, text messaging devices, computers, portable computers, vehicle locating devices, vehicle security devices, communication devices, wireless transceivers or other devices with a wireless communications interface. Base station transceivers 102-106, also commonly referred to simply as base stations or nodes, are connected to a central entity or central network unit 130. The central entity 130 may be a base station controller (“BSC”) in a base station subsystem (“BSS”), a Radio Network Controller (“RNC”) in a Radio Access Network (“RAN”), or, for GSM, General Packet Radio Service (“GPRS”) or UMTS system, an SMLC or an equivalent. The connection from each base station to a BSC, SMLC or other central network entity may employ a direct transmission link, e.g., a wired connection, microwave link, Ethernet connection, and the like, or may be employed by one or more intermediate entities, e.g., an intermediate BSC in the case of a connection from a BTS to an SMLC for GSM. Each mobile station 120, 122 may periodically measure the transmission timing difference between pairs of base stations 102-106. For example, a mobile station 120 may measure the difference in transmission timing for communication from its serving base station 102 and from one or more neighboring base stations, e.g., 106 and/or 103.

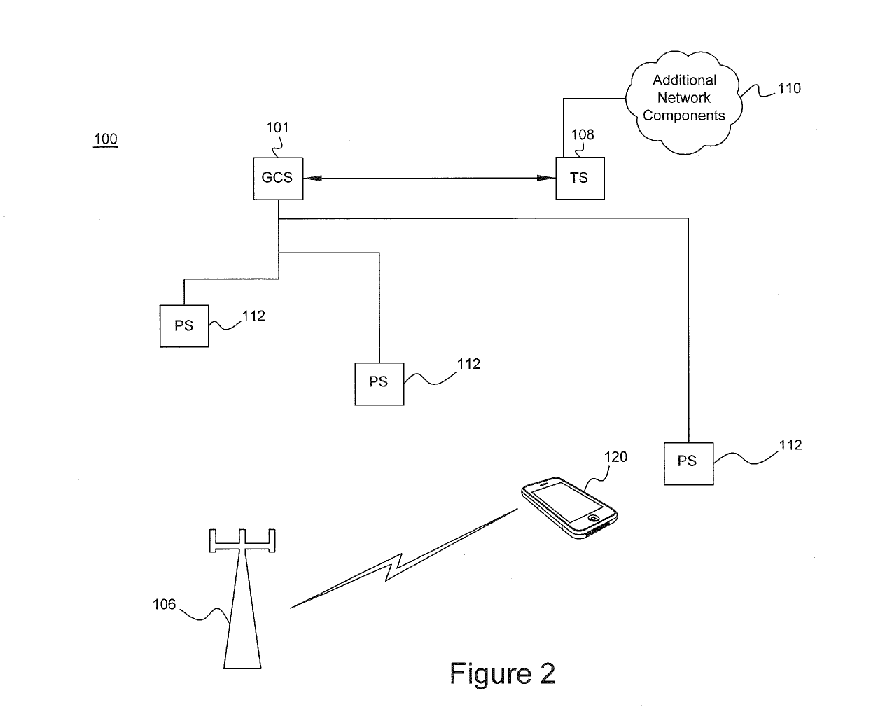

FIG. 2 is a diagram of a basic architecture for one embodiment of the present subject matter. With reference to FIG. 2, a mobile device 120 of interest may be in communication with a base station 106 in an exemplary communications network 100. A Geolocation Control System (“GCS”) 101 in the network 100 may receive tasking from a Tasking Server (“TS”) 108. An exemplary network may be a UMTS network, a GSM network, a TDMA network, CDMA network, a WiMax network, a WiFi network, networks utilizing EDVO, a CDMA2000 network, and 1×RTT standards or another equivalent network. The TS 108 may be operably connected to other components 110 of the communications network 100. The network 100 may also include one or more Positioning Determination Units (“PDU”) 112 or other sensors such as proximity sensors and LMUs depicted in FIGS. 1 and/or 2. Of course, these sensors, units and equivalents may also be co-located or remote from other sensors, units and/or stations. These PDUs 112 may receive a location request from the GCS 101 and may attempt to detect the mobile device 120 of interest. Any one or each PDUs 112 may also report the quality of its detection measurements to the GCS 101.

In other embodiments of the present subject matter, the TS 108 may be embedded in certain network core components (e.g., Serving Mobile Location Center (“SMLC”), etc.). The TS 108 may also be embedded within one or more PDUs 112 (to receive off-the-air tasking). Alternatively, the TS 108 may be supplied by an independent receiver apparatus, the PDUs 112 may be embedded in a complementary repeater or Distributed Antenna System (“DAS”). In additional embodiments, the PDUs 112 may be provided by one or more apparatuses connected to the repeater or DAS, and/or the PDUs 112 supplied by an independent, standalone, receiver apparatus.

By way of example, in the embodiment where a PDU 112 is embedded in a repeater or DAS, this may be accomplished by adding software to an existing repeater/DAS to support the detection, and/or may be accomplished by adding receiver and/or processing hardware to perform any appropriate proximity detection functions. Further, in the embodiment where the PDU 112 is connected to a repeater/DAS system, the PDU 112 may also comprise receiver/processor hardware and an inline or passive coupler interface to the repeater/DAS signaling path. Additionally, when the PDU 112 is employed as an independent receiver, the PDU 112 may include both receiver and processor hardware and/or an antenna interface if none exist.

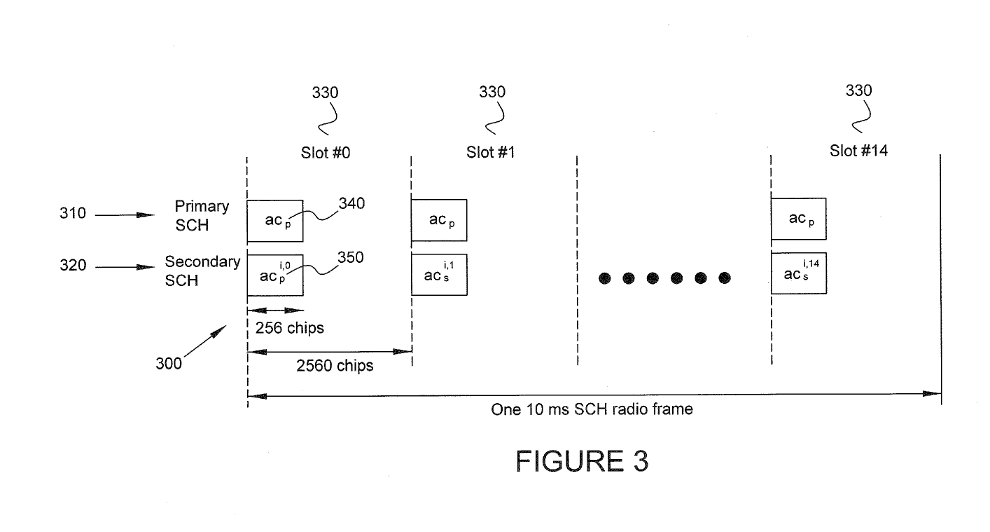

During a cell search, the mobile station 120 may search for a cell and determine the downlink scrambling code and frame synchronization of that cell. The cell search is typically carried out in three steps, slot synchronization, frame synchronization and code-group identification, and scrambling-code identification. During the first step of the cell search procedure the mobile station 120 uses a downlink signal commonly referred to as the Synchronization Channel (“SCH”). FIG. 3 is an illustration of the structure of a synchronization channel radio frame according to an embodiment of the present subject matter. With reference to FIG. 3, the SCH 300 consists of two sub channels, the Primary SCH 310 and the Secondary SCH 320. The Primary and Secondary SCH 310, 320 are divided into fifteen slots 330, each having a length of 2560 chips.

The Primary SCH 310 transmits a modulated code having a length of 256 chips and transmits the Primary Synchronization Code (“PSC”) 340 (denoted as cₚ) once every downlink slot 330. The PSC 340 is the same for every cell in the system and does not have any complex scrambling thereon.

The Secondary SCH 320 consists of repeatedly transmitting a sequence of modulated codes having a length of 256 chips. Secondary Synchronization Codes (“SSC”) 350 are transmitted in parallel with the Primary SCH 310. The SSC 350 is denoted as cₛ^{ik} where i=1, 2, . . . , 64 and represents the number of the scrambling code group, and where k=0, 1, . . . , 14 and represents the slot number. Each SSC 350 may be selected from a set of sixteen different codes having a length of 256 chips. This sequence on the Secondary SCH 320 indicates to which of the code groups a cell's downlink scrambling code belongs. The primary and secondary synchronization codes are modulated by the symbol a shown in FIG. 3 indicating the presence/absence of space time block coding based transmit antenna diversity (“STTD”) encoding on the Primary Common Control Physical Channel (“P-CCPCH”).

The P-CCPCH is a fixed rate (30 kbps, SF=256) downlink physical channel used to carry the broadcast channel (“BCH”). During slot synchronization, the mobile station may utilize the SCH's primary synchronization code to acquire slot synchronization to a cell. This is typically done with a single matched filter or any similar device matched to the PSC.

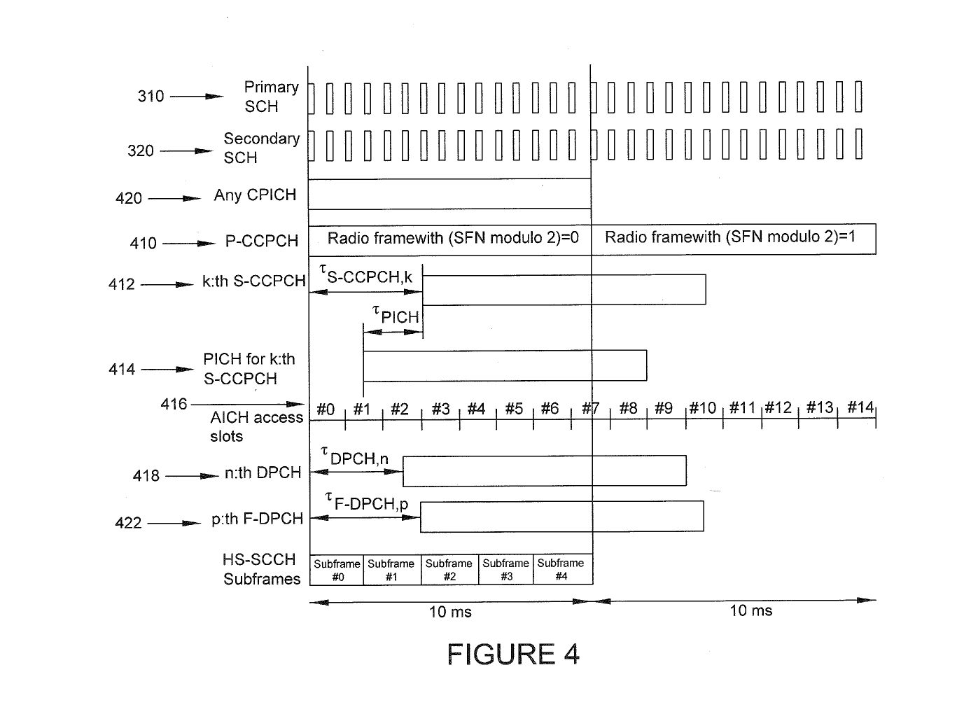

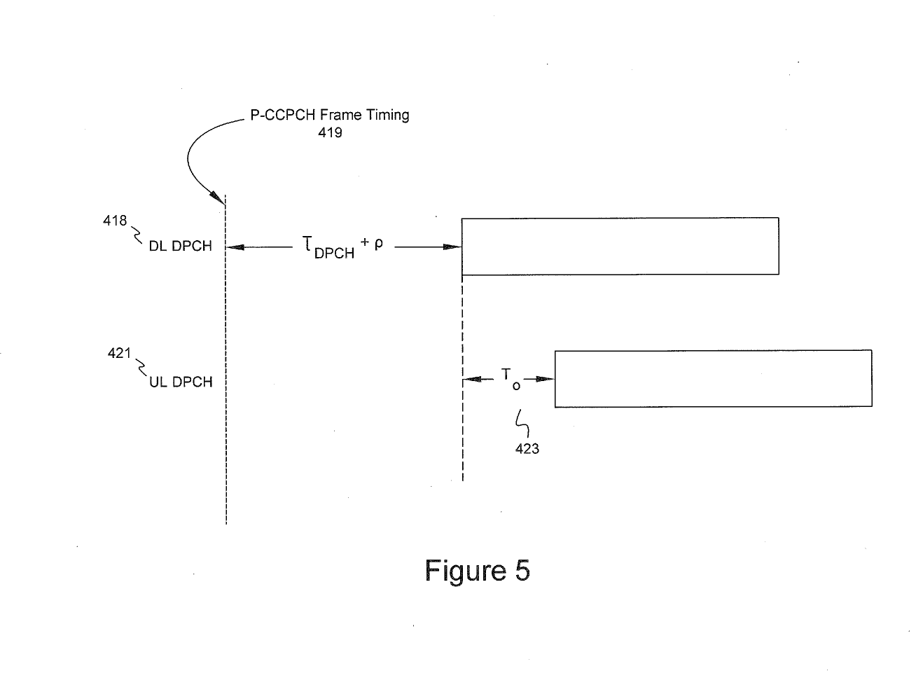

FIG. 4 is an illustration of the timing relationships between downlink physical channels according to an embodiment of the present subject matter. FIG. 5 is an illustration of the timing relationships at a mobile device or user equipment (“UE”). With reference to FIGS. 4 and 5, the P-CCPCH 410, on which the cell system frame number (“SFN”) is transmitted, is used as the timing reference for all the physical channels, directly for downlink and indirectly for uplink. The Primary SCH 310, the Secondary SCH 320, the Primary and Secondary CPICH 420, and the P-CCPCH 410 all have identical frame timings for a given cell.

Generally, cell system information is broadcast on the P-CCPCH. The Secondary Common Control Physical Channel (“S-CCPCH”) timing 412 may be different for different S-CCPCHs, but the offset from the P-CCPCH frame timing is a multiple of 256 chips, i.e., τ_{s-CCPCH,k}=Tₖ*256 chip, Tₖε{0, 1, . . . 149}. The PICH timing 414 is τ_{PICH}=7680 chips prior to its corresponding S-CCPCH frame timing 412. The AICH access slot #0 starts the same time as a P-CCPCH frame 410 with SFN modulo 2=0. The Downlink Dedicated Physical Channel (“DPCH”) timing 418 may be different for different DPCHs, but the offset from the P-CCPCH frame timing 419 is a multiple of 256 chips, i.e., τ_{DPCH,n}=Tₙ*256 chip, Tₙε{0, 1, . . . , 149}. The Fractional DPCH (“F-DPCH”) timing 422 may be different for different F-DPCHs, but the offset from the P-CCPCH frame timing 419 is a multiple of 256 chips, i.e., τ_{F-DPCH,p}=Tₚ*256 chip, Tₚε{0, 1, . . . , 149}. An exemplary UMTS frame is 10 msec long and may be sub-divided into fifteen slots.

The sectors of a base station are generally locked to a common reference clock or frequency source. Therefore, the relative time differences of the downlink frames of the sectors are constant, although the reference clock may itself drift. The time difference of the downlink frames in different sectors at the same site is generally a multiple of 256 chips. Section 5 of TS 25.402 provides a comprehensive list of synchronization parameters and clarifies the timing relationship of the sectors and is incorporated herein by reference.

The mobile station or UE may have the capability to follow the frame timing change of the serving site (e.g., Node B). At the mobile station, the uplink DPCCH/DPDCH frame transmission takes place approximately Tₒ chips 421 after the reception of the first detected or significant path (in time) of the corresponding downlink DPCCH/DPDCH or F-DPCH frame. Tₒ may generally be defined as 1024 chips. The mobile station initial transmission timing error may be maintained within ±1.5 chips at the mobile station. The reference point for the mobile station initial transmit timing control requirement is the time when the first detected path (in time) of the corresponding downlink DPCCH/DPDCH frame is received from the reference cell plus Tₒ chips. When the mobile station is not in soft handover, the reference cell is the one the mobile station has in the active set. The cell, which may be selected as a reference cell, remains as a reference cell even if other cells are added to the active set. In the instance that the reference cell is removed from the active set, the mobile station adjusts its respective transmit timing no later than the time when the whole active set update message is available at the mobile station. The mobile station is also capable of changing the transmission timing according to the received downlink DPCCH/DPDCH frame. Thus, when the transmission timing error between the mobile station and the reference cell exceeds ±1.5 chips, the mobile station is required to adjust its timing to within ±1.5 chips. Generally adjustments made to the mobile device timing follow the rules that the maximum amount of the timing change in one adjustment is ¼ chip, the minimum adjustment rate is approximately 233 ns per second, and the maximum adjustment rate is ¼ chip per 200 msec. Thus, within any given 800*d msec period, a mobile device transmit timing should not change in excess of ±d chip from the timing at the beginning of this 800*d msec period, where 0≦d≦¼.

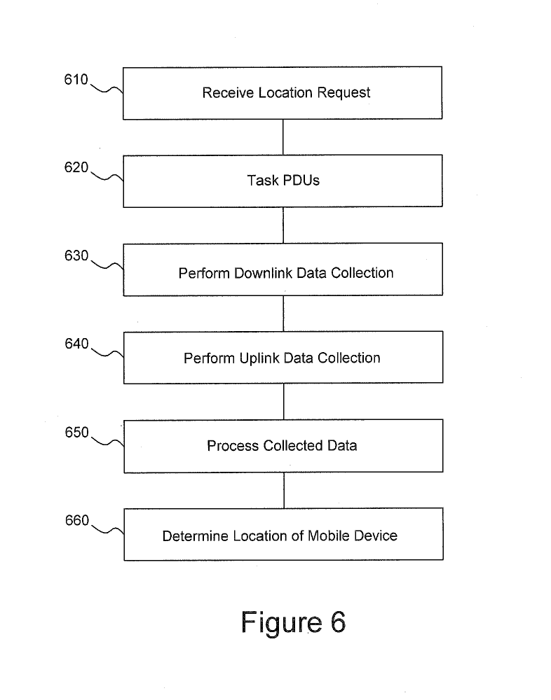

FIG. 6 is a block diagram of one embodiment of the present subject matter. With reference to FIG. 6, an exemplary GCS may receive a location request for a call served by a cell at step 610. The GCS may then task one or more PDUs associated with the cell at step 620. These PDUs upon receiving tasking information may perform a DL data collection and determine an absolute DL frame timing for the cell at step 630. Exemplary tasking information may be, but is not limited to, a Tasking Command that includes UL call related parameters along with the DL-PSC and in other embodiments may also include coarse cell framing timing information. In one embodiment, exemplary DL data or channel information may be the frequency that is passed as tipping information as part of the location request. Other embodiments as described herein may include DL-PSC information, other tipping information and timing information. The PDU may then perform an UL data collection at step 640 where the start time of the UL data collection is determined using the DL frame timing. The collected UL data may then be processed using an exemplary signal detection algorithm and the results provided to the GCS at step 650 whereby a geographic location of the respective device determined based upon the received results from the tasked PDU(s) at step 660.

With continued reference to FIG. 6, in one embodiment of the present subject matter where the DL-PSC and coarse frame timing are available, step 630 may employ the DL P-CPICH channel for estimating fine frame timing to compensate for any drift in base station timing since the last frame timing estimation in a respective database. Coarse frame timing may be used to generate the starting time for the DL data collection. The collected DL data may then be correlated and the fine frame timing estimated. As coarse frame timing is known, the correlation search window would be small (+N chips) and the amount of data collected also small (M slots). In this embodiment, the search window value (N) may be adjusted based upon the frequency of a coarse frame timing update frequency.

In another embodiment of the present subject matter where only the DL-PSC is available, step 630 may estimate the DL frame timing using the P-SCH and the DL P-CPICH channels. For example, the P-SCH may be employed to obtain the DL slot timing. Using this DL slot timing and the DL-PSC, DL frame timing may be estimated by correlating the reference P-CPICH with received DL data on the slot starting times. As is known, a frame has 38400 chips and obtaining a DL frame marker with the PSC alone would require the testing of all 38400 combinations for a match. Through utilization of the P-SCH in this embodiment, however, the uncertainty of 38400 options may be narrowed to fifteen options. Thus, through the creation of a reference signal for the PSC, a significant reduction in time and processing power may be achieved. In the event of multiple P-SCH detection, the DL-PSC may be used to identify the correct DL frame timing. In one embodiment, an exemplary reference signal may be a function of the pilot bits in an UL channel. Further, the number of pilot bits may be determined from tipping information, and a complex baseband signal created therefrom and used as a reference signal. Additional information regarding such reference signals is described in co-pending U.S. application Ser. No. 12/246,156, filed Oct. 6, 2008, entitled “System and Method of UMTS UE Location Using Uplink Dedicated Physical Control Channel and Downlink Synchronization Channel,” the entirety of which is incorporated herein by reference.

In a further embodiment of the present subject matter where the DL-PSC is not available, step 630 may estimate DL slot timing using the DL P-SCH. Thus, the DL slot timing would be assumed to be the DL frame timing; however, in the event of multiple P-SCH detection, this method would not be optimum as the slot timing could not be uniquely associated with a cell.

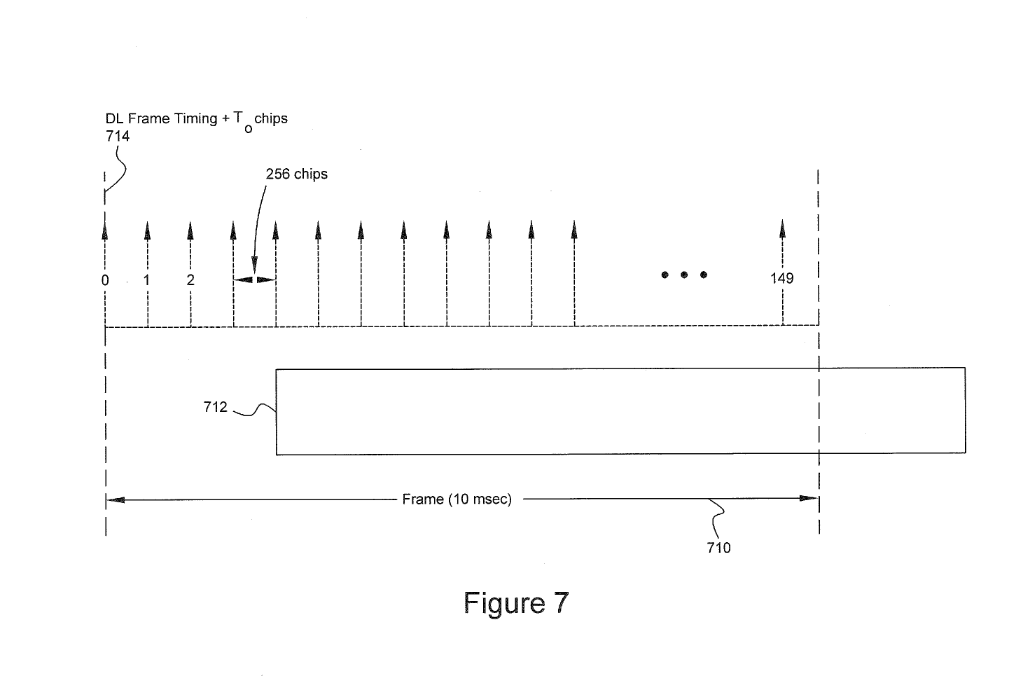

FIG. 7 is an illustration of Uplink DPCH timing at a PDU or other node. With reference to FIGS. 6 and 7, at step 640, an UL data collection may be performed where the start time of the UL data collection is determined using DL frame timing. By way of a non-limiting example, data from an UL DPCH channel 712 may be collected. UL DPCH pilot bits are distributed in the 15 slots that constitute a frame 710 which is 10 msec long. As the τ_{DPCH,n} value for the DL DPCH is not known, the UL DPCH frame starting time could be anywhere in the 10 msec frame window 710. Conventionally, the computational requirements and the processing time in determining the UL DPCH frame starting time are massive. Embodiments of the present subject matter, however, may collect a predetermined amount of data, e.g., 10 msec, 15 msec, 20 msec, etc. In one embodiment, the amount of collected data may be 20 msec so one full overlap with the sliding window on a reference signal is performed. The collected UL data may then be processed to detect the presence of a signal. In one embodiment, to detect the signal, a reference signal may be generated and correlated with the received signal. As the starting frame for the UL signal can be anywhere in the 10 msec frame window 710, the search window for the correlation is may be a predetermined number of chips, e.g., 38400 chips, etc. Embodiments of the present subject matter may also reduce the processing time involved in searching for the signal through utilization of DL frame timing 714 and through utilization of the relationship that DL DPCH frame alignment offset is an integer multiple of 256 chips.

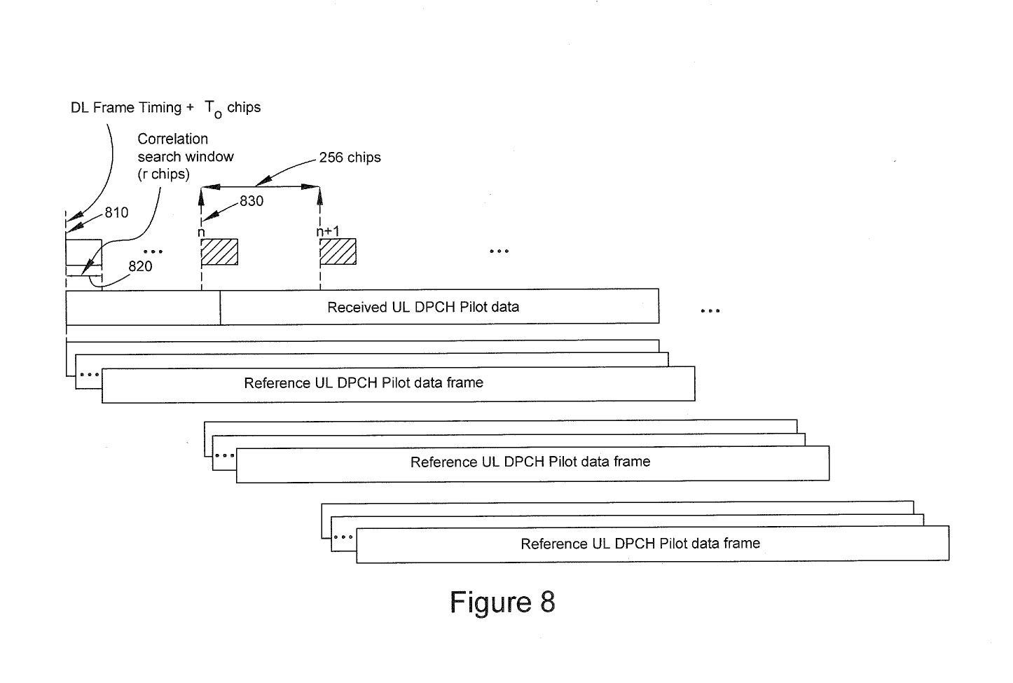

FIG. 8 is an illustration of a signal correlation scheme according to one embodiment of the present subject matter. With reference to FIG. 8, a search for a signal may commence at a DL frame marker 810. This search may be performed by correlating a reference signal with the received signal over a sliding window 820 of r chips. Once the end of the window is reached, the starting point for a subsequent correlation 830 may slide or jump 256 chips and this sliding correlation continued for r chips. This process may be repeated until the end of the respective frame (e.g., 10 msec in this example). In another embodiment, the correlation may be continued until detection of the signal is achieved. Exemplary detection techniques and algorithms are disclosed in co-pending U.S. application Ser. No. 12/246,156, filed Oct. 6, 2008, entitled “System and Method of UMTS UE Location Using Uplink Dedicated Physical Control Channel and Downlink Synchronization Channel,” the entirety of which is incorporated herein by reference. Any of the detection techniques and algorithms described in U.S. application Ser. No. 12/246,156 may be employed to detect a signal of interest and/or process collected UL data. Thus, the number of correlation points may now be r*150 as opposed to 256*150. Further, processing time may now be reduced by a factor of r/256. It follows that, the smaller the r the greater is the reduction in the processing time. The search window r is generally dependent upon the propagation delay of the respective system. For example, in an indoor DAS system, the propagation delay may possess the contributing factors of the range of the mobile station from the antenna and the delay through the DAS system. Thus in an indoor DAS system, if the delay through the DAS system is available or can be estimated, then the effective propagation delay may be limited to the range of the mobile from the antenna. This range may be small in an indoor environment thereby leading to a smaller search window r.

In one embodiment of the present subject matter, an exemplary GCS 101 or other network component may maintain a database of cell specific information. In one embodiment, the database may include a mapping of cell IDs to a combination of any one or several of the following parameters: DL-Primary Scrambling or Synchronization Code, frame timing of the cell, scrambling code group, PDU Site ID and equivalents. The database may also be updated at pre-determined or periodic intervals. Such a database may be created through a network dump from a Network Operator containing the Cell-ID to the parameter mapping. As discussed above, cell frame timing may be obtained by performing a DL data collection for all the cells in the database, and the P-CPICH may be employed to obtain the frame timing. The DL data collection may also be performed at a pre-determined frequency or periodicity to update the frame timing. In another embodiment, the database may be created without Network Operator assistance. By way of a non-limiting example, the Cell-ID to parameter mapping may be accomplished by decoding the System Information Block (e.g., SIB3/SIB4) transmitted on the P-CCPCH and extracting the Cell-ID thereon. In this exemplary process, the cell primary synchronization or scrambling code, scrambling code group, SFN, and/or cell frame timing may also be identified and added to the database. Of course, this exemplary process may also be repeated at a pre-determined frequency or periodicity. In yet another embodiment, the GCS 101 may determine UL start times as a function of DL Frame times from the database and send the same to the PDU(s) or other nodes. Thus, the PDU(s) or other nodes may then perform the UL data collection as described above.

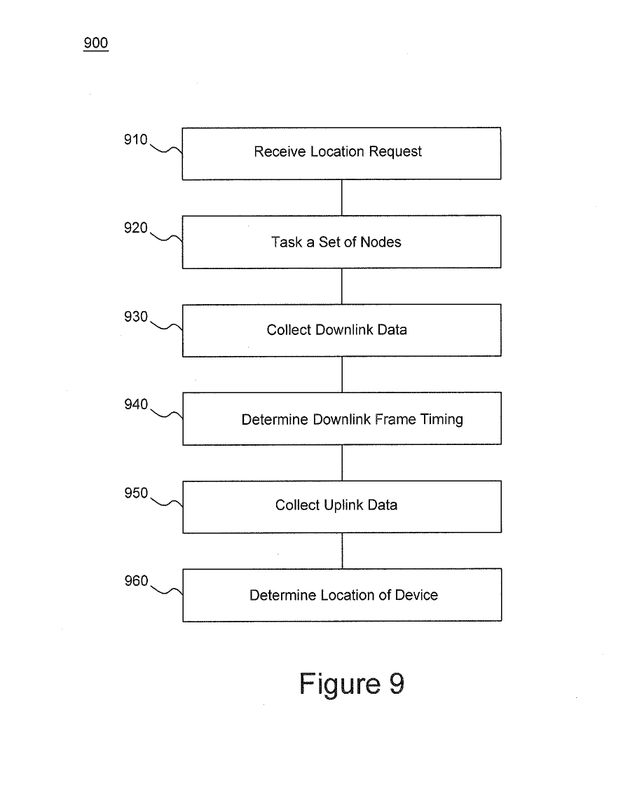

FIG. 9 is an algorithm according to one embodiment of the present subject matter. With reference to FIG. 9, a method 900 for determining the location of a device is provided. At step 910, a location request for a mobile device served by a base station may be received, and at step 920 a set of nodes associated with the serving base station tasked. DL data may be collected at a first node at step 930, the DL data from a DL signal received from the serving base station. At step 940, DL frame timing may be determined as a function of the collected DL data. In one embodiment, step 940 may further include determining a search window for collecting UL data, the search window determined as a function of the determined DL frame timing. In another embodiment, step 940 may include determining DL frame timing as a function of the DL P-CCPCH and determining a search window for collecting UL data, the search window determined as a function of the determined DL frame timing. A further embodiment of step 940 may include determining DL slot timing as a function of a P-SCH and determining DL frame timing as a function of the determined DL slot timing and a DL-PSC. Yet another embodiment of step 940 may include determining DL slot timing using a P-SCH and associating DL frame timing as the determined DL slot timing. UL data may then be collected at step 950 at a second node as a function of the determined DL frame timing, and a location of the device determined at step 960 as a function of the collected UL data. In one embodiment, the first and second nodes may be the same node. Further, the first and/or second node may be an LMU or equivalent and may also be co-located with the serving base station.

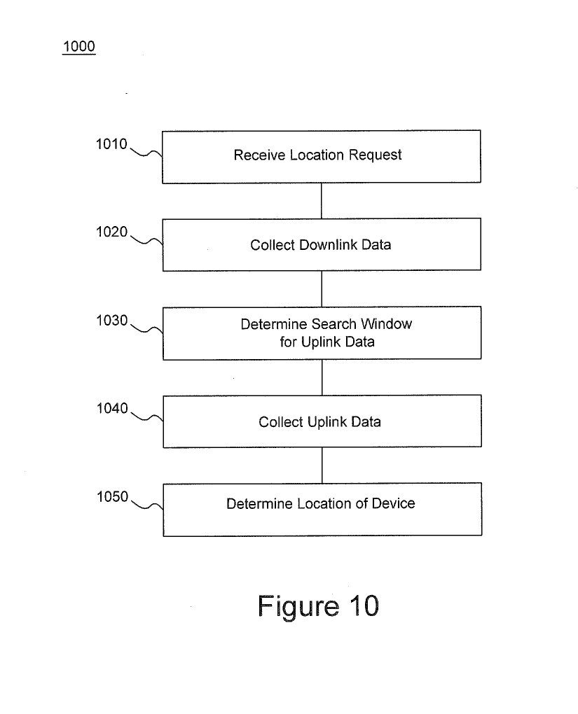

FIG. 10 is an algorithm according to another embodiment of the present subject matter. With reference to FIG. 10, a method 1000 for determining the location of a mobile device served by a base station in a communications network is provided. At step 1010, a location request for the mobile device may be received and DL data collected from the serving base station at step 1020. In one embodiment, step 1020 may further include determining DL frame timing as a function of the DL P-CCPCH. A further embodiment of step 1020 may include determining DL slot timing as a function of a P-SCH and determining DL frame timing as a function of the determined DL slot timing and a DL-PSC. Yet another embodiment of step 1020 may include determining DL slot timing using a P-SCH and associating DL frame timing as the determined DL slot timing. At step 1030, a search window for UL data may be determined as a function of the collected DL data, and UL data collected at a network node as a function of the search window at step 1040. A location for the mobile device may then be determined at step 1050 as a function of the collected UL data.

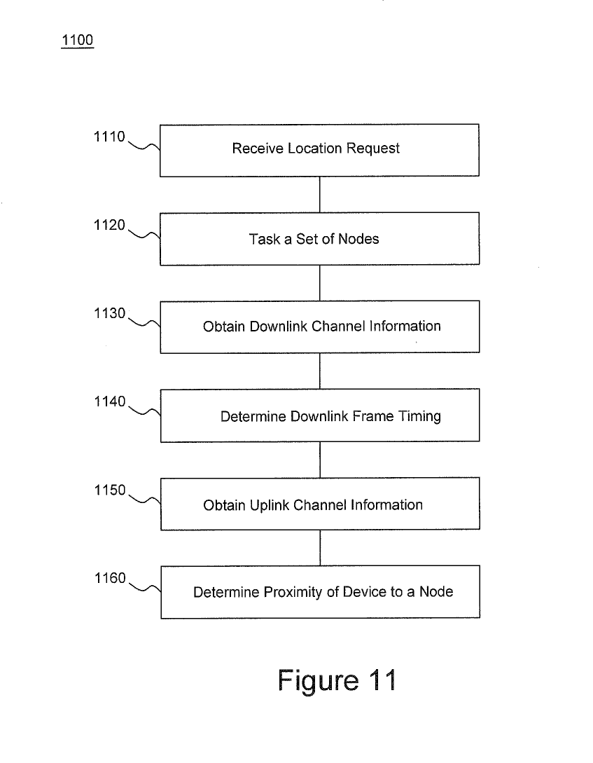

FIG. 11 is an algorithm according to a further embodiment of the present subject matter. With reference to FIG. 11, a method 1100 for determining the proximity of a mobile device to a node in a communications network is provided. At step 1110, a location request for a mobile device may be received and, at step 1120, tasking a set of nodes associated with a cell serving the mobile device associated with the location request. At step 1130, DL channel information may be obtained and DL frame timing determined at step 1140 as a function of the obtained DL channel information. In one embodiment, step 1140 may further include determining a search window for obtaining UL channel information as a function of the determined DL frame timing. A further embodiment of step 1140 may include determining DL frame timing as a function of a DL P-CCPCH and determining a search window for obtaining UL channel information as a function of the determined DL frame timing. An additional embodiment of step 1140 may include determining DL slot timing as a function of a P-SCH and determining DL frame timing as a function of the determined DL slot timing and a DL PSC. Yet another embodiment of step 1140 may include determining DL slot timing using a P-SCH and associating DL frame timing as the determined DL slot timing. At step 1150, UL channel information may be obtained as a function of the determined DL frame timing. At step 1160, the proximity of the mobile device to the node may be determined as a function of the obtained UL channel information.

The present disclosure can be implemented by a general purpose computer programmed in accordance with the principals discussed herein. It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine-readable storage substrate, a memory device, or a combination of one or more of them.

The term “processor” encompasses all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms data memory including non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the claimed subject matter, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As shown by the various configurations and embodiments illustrated in FIGS. 1-11, a system and method for UMTS proximity detection with UL and DL signals have been described.

While preferred embodiments of the present subject matter have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What we claim is:

1. A method for determining the location of a device comprising the steps of:
(a) receiving a location request for a mobile device served by a base station;
(b) tasking a set of nodes associated with the serving base station;
(c) collecting downlink (“DL”) data at a first node, the DL data from a DL signal received from the serving base station;
(d) determining DL frame timing as a function of the collected DL data;
(e) collecting uplink (“UL”) data at a second node as a function of the determined DL frame timing; and
(f) determining a location for the device as a function of the collected UL data.

2. The method of claim 1 wherein the step of determining DL frame timing further comprises determining a search window for collecting UL data, the search window determined as a function of the determined DL frame timing.

3. The method of claim 1 wherein the step of determining DL frame timing further comprises:
(i) determining DL frame timing as a function of a DL primary common control physical channel (“P-CCPCH”); and
(ii) determining a search window for collecting UL data, the search window determined as a function of the determined DL frame timing.

4. The method of claim 1 wherein the step of determining DL frame timing further comprises:
(i) determining DL slot timing as a function of a primary synchronization channel (“P-SCH”); and
(ii) determining DL frame timing as a function of the determined DL slot timing and a DL primary synchronization code (“PSC”).

5. The method of claim 1 wherein the step of determining DL frame timing further comprises:
(i) determining DL slot timing using a primary synchronization channel (“P-SCH”); and
(ii) associating DL frame timing as the determined DL slot timing.

6. The method of claim 1 wherein the first and second nodes are the same node.

7. The method of claim 1 wherein the first or second node is a Location Measurement Unit.

8. The method of claim 1 wherein one of the two nodes and said serving base station are co-located.

9. The method of claim 1 wherein said mobile device is selected from the group consisting of: cellular telephone, text messaging device, computer, portable computer, vehicle locating device, vehicle security device, communication device, and wireless transceiver.

10. The method of claim 1 wherein said set of nodes are installed in a communications network selected from the group consisting of: Universal Mobile Telecommunications System (“UMTS”) network, Worldwide Interoperability for Microwave Access (“WiMax”) network, Global System for Mobile Communications (“GSM”) network, WiFi network, Code Division Multiple Access (“CDMA”) network, and combinations thereof.

11. The method of claim 1 wherein one of said nodes operates under a standard selected from the group consisting of: IS-95, Evolution-Data Optimized (“EDVO”), CDMA2000, and 1 times Radio Transmission Technology (“1×RTT”).

12. In a method for determining the location of a mobile device served by a base station in a communications network comprising the steps of receiving a location request for the mobile device and collecting downlink (“DL”) data from the serving base station, the improvement comprising determining a search window for uplink (“UL”) data as a function of the collected DL data, collecting UL data at a network node as a function of the search window, and determining a location for the mobile device as a function of the collected UL data.

13. The method of claim 12 wherein the step of collecting DL data further comprises determining DL frame timing as a function of a DL primary common control physical channel (“P-CCPCH”).

14. The method of claim 12 wherein the step of collecting DL data further comprises:
determining DL slot timing as a function of a primary synchronization channel (“P-SCH”); and
determining DL frame timing as a function of the determined DL slot timing and a DL primary synchronization code (“PSC”).

15. The method of claim 12 wherein the step of collecting DL data further comprises:
determining DL slot timing using a primary synchronization channel (“P-SCH”); and
associating DL frame timing as the determined DL slot timing.

16. A method for determining the proximity of a mobile device to a node in a communications network comprising the steps of:
(a) receiving a location request for a mobile device;
(b) tasking a set of nodes associated with a cell serving the mobile device associated with the location request;
(c) obtaining downlink (“DL”) channel information;
(d) determining DL frame timing as a function of the obtained DL channel information;
(e) obtaining uplink (“UL”) channel information as a function of the determined DL frame timing; and
(f) determining the proximity of the mobile device to the node as a function of the obtained UL channel information.

17. The method of claim 16 wherein the step of determining DL frame timing further comprises determining a search window for obtaining UL channel information as a function of the determined DL frame timing.

18. The method of claim 16 wherein the step of determining DL frame timing further comprises:
(i) determining DL frame timing as a function of a DL primary common control physical channel (“P-CCPCH”); and
(ii) determining a search window for obtaining UL channel information as a function of the determined DL frame timing.

19. The method of claim 16 wherein the step of determining DL frame timing further comprises:
(i) determining DL slot timing as a function of a primary synchronization channel (“P-SCH”); and
(ii) determining DL frame timing as a function of the determined DL slot timing and a DL primary synchronization code (“PSC”).

20. The method of claim 16 wherein the step of determining DL frame timing further comprises:
(i) determining DL slot timing using a primary synchronization channel (“P-SCH”); and
(ii) associating DL frame timing as the determined DL slot timing.
